(19) United States
(12) Patent Application Publication
(10) Pub. No.: US 2026/0111991 A1
(43) Pub. Date: Apr. 23, 2026

(54) HYBRID GRAPHICS PROCESSING UNIT CONFIGURATION FOR VIRTUAL MACHINES

(71) Applicants: ATI TECHNOLOGIES ULC, MARKHAM (CA); ADVANCED MICRO DEVICES, INC., Santa Clara, CA (US)

(72) Inventors: Hui Yu, Richmond Hill (CA); Rui Huang, Shanghai (CN); YuQi Zhang, Shanghai (CN)

(21) Appl. No.: 18/918,410

(22) Filed: Oct. 17, 2024

(51) Int. Cl. G06T 1/20; G06F 3/14

(52) U.S. Cl. CPC G06T 1/20; G06F 3/14

(57) ABSTRACT

A virtual machine (VM) hybrid graphics processing unit configuration includes a first parallel processing unit and a second parallel processing unit. The first parallel processing unit is shared among a plurality of VMs and is configured to execute operations for the plurality of VMs, wherein the operations place computational demands that are up to a threshold. The second parallel processing unit is powered up for heavier workloads when the operations for one of more of the plurality of VMs place computational demands that exceed the threshold or when selected by a user. The second parallel processing unit is assigned to execute the operations for one VM of the plurality of VMs. When the operations of the workloads issued by the VMs are under the threshold, the second parallel processing unit is powered down.

### BACKGROUND

Some processing systems employ a virtualization environment in which multiple virtual machines (VMs) operate on a single hardware platform to increase efficiency and optimize hardware utilization. The VMs are isolated from one another and are able to run their own operating systems and/or applications as if the VMs were running on independent processing systems. The processing system (also referred to as a “host processing system” or a “host,” for brevity) employs a hypervisor to create the VMs, manage the VMs, and provide an interface between the host's hardware resources and the VMs. The hypervisor enables the host's hardware resources (e.g., graphics processing resources) to appear to each of the VMs as dedicated local hardware so that the VM may execute workloads.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is an example of a processing system employing a VM hybrid graphics processing unit system in accordance with some embodiments.

FIG. 2 is an example of portions of the processing system of FIG. 1 implementing a VM hybrid graphics processing unit system in accordance with some embodiments.

FIG. 3 is an example of a diagram illustrating the VM hybrid graphics processing unit system utilizing a first virtualized graphics processing unit in accordance with some embodiments.

FIG. 4 is an example of a diagram illustrating the VM hybrid graphics processing unit system utilizing a second discrete graphics processing unit for heavier workloads in accordance with some embodiments

FIG. 5 is an example of a flow diagram illustrating a method for a processing system to employ a VM hybrid graphics processing unit system in accordance with some embodiments.

### DETAILED DESCRIPTION

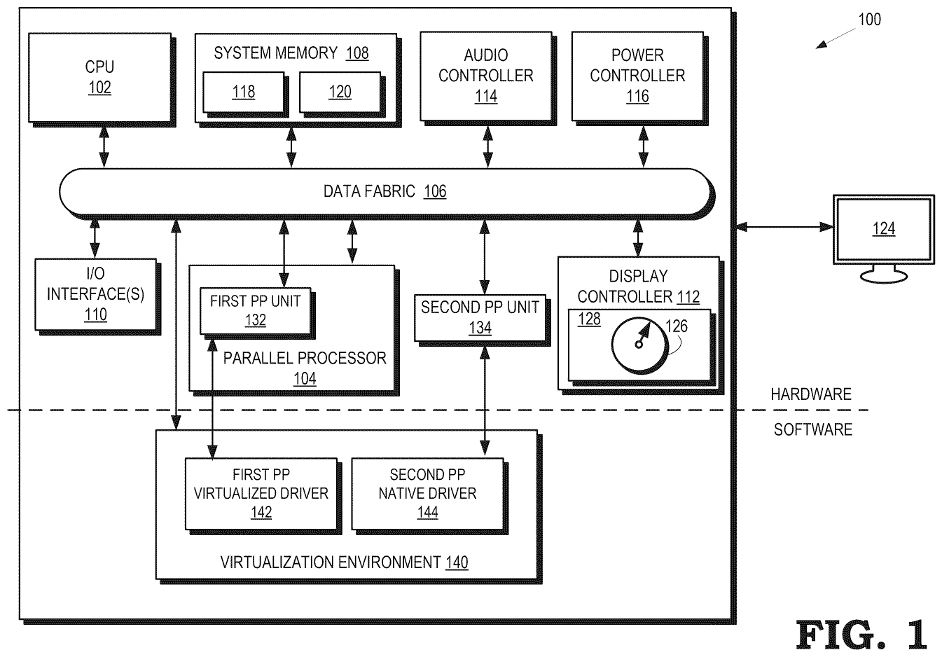

VMs executing within a virtualization environment on a host share a common set of hardware resources for performing workloads associated with operating systems or applications running on the VMs. In some cases, the host's resources that are virtualized for use by the VMs include a central processing unit (CPU), a parallel processing unit such as an integrated graphics processing unit (iGPU) or a neural processing unit (NPU), a video encoder/decoder, audio controllers, and the like. A hypervisor manages and allocates the host's hardware resources according to a scheduling protocol to ensure isolation between the VMs. For example, the hypervisor virtualizes the host's iGPU and allocates the iGPU among the VMs for performing graphics workloads according to a particular schedule or allocation pattern. However, virtualizing and allocating the iGPU in this manner may sometimes not provide sufficient resources for heavier graphics workloads. FIGS. 1-5 describe a VM hybrid graphics processing unit configuration that includes a discrete GPU (dGPU) that is selectively powered on by the host for heavier workloads. The dGPU is a Peripheral Component Interconnect Express (PCIe) device and works under a Peripheral Component Interconnect (PCI) passthrough function in collaboration with the virtualized iGPU. By selectively powering on the dGPU and using it to render or assist in rendering heavier graphics workloads, the VM hybrid graphics processing unit system extends the graphics processing capabilities of the VMs and improves performance.

To illustrate, in some embodiments a processing system includes a first parallel processing unit and a second parallel processing unit. The first parallel processing unit is integrated into a parallel processor and is shared among a plurality of VMs executing on the processing system (i.e., the first parallel processing unit is virtualized). The first parallel processing unit is configured to execute operations for the plurality of VMs within a first operational range up to a threshold. The first operational range is, at least in part, determined based on the first parallel processing unit's computational resources' (e.g., cores') capacity to execute operations (such as rendering operations) associated with the workloads issued by the plurality of VMs within an acceptable time frame, where the upper limit of the operational range is the threshold. That is, the threshold is based on a maximum computational capacity of the first parallel processing unit to execute operations issued by the plurality of VMs to meet a workload bandwidth. In some embodiments, the threshold is static and based on the total number of computational resources of the first parallel processing unit. In other embodiments, the threshold is dynamically adjusted as the availability of the computational resources of the first parallel processing unit changes (e.g., the threshold may be dynamically adjusted in situations where the first parallel processing unit is used to perform other tasks). In yet other embodiments, a user can decide to use a specific parallel processing unit (i.e., the first or the second parallel processing unit) to directly execute operations. For example, the first parallel processing unit is an iGPU in a virtualization environment implemented by a hypervisor executing on the processing system, and the iGPU includes a number of cores to execute operations related to graphics workloads issued by the VMs up to the threshold (e.g., a pre-defined amount of graphics related operations). In some cases, virtualizing the iGPU's hardware resources and sharing them among the plurality of VMs may not be sufficient for processing graphics workloads that place bandwidth and/or computational demands that exceed the threshold (referred to herein as “heavier graphics workloads”) within an acceptable time frame. The processing system employs the second parallel processing unit (e.g., a dGPU on a separate chip or die than the parallel processor with the iGPU) to execute operations for at least one VM of the plurality of VMs based on the operations for the at least one VM exceeding the threshold or according to the user's configuration. That is, for cases involving heavier VM graphics workloads (e.g., rendering for high-resolution video or video games) that exceed the threshold or for cases that the user chooses to enhance performance, the processing system powers on the dGPU to assist the virtualized iGPU, and the iGPU passes the heavier graphics workloads to the dGPU. The dGPU executes the heaver graphics workloads and transfers the rendered data to the iGPU, which then passes the rendered data to a host emulator or display controller for display. Thus, the processing system implements a mechanism to offload heavier VM graphics workloads that exceed the threshold from the iGPU to the dGPU to increase performance. For lighter VM graphics workloads that fall under the threshold, the rendering is performed by the iGPU, and the processing system powers the dGPU down, thereby saving power.

FIG. 1 shows a diagram of a processing system 100 employing a VM hybrid graphics processing unit configuration in accordance with some embodiments. The processing system 100, in at least some implementations, includes at least one or more processing devices, such as a central processing unit (CPU) 102, a parallel processor 104 including a first parallel processing (PP) unit 132 (e.g., an iGPU), and a second parallel processing (PP) unit 134 (e.g., a dGPU), a fabric 106, memory 108, an input/output (I/O) interface(s) 110, a display controller 112, an audio controller 114, a power controller 116, and the like. The processing system 100, in at least some implementations, is a computer, laptop, mobile device, server, vehicle human-machine interface, or any of various other types of computing systems or devices. For example, in some embodiments, the processing system 100 is included in an automotive system and is used to generate images or content displayed at one or more display screens (e.g., a dashboard display, a central console display, or the like) in the automotive system. It is noted that the number of components of the processing system 100 may vary. It is also noted that in implementations, processing system 100 includes other components not shown in FIG. 1, and the processing system 100, in at least some implementations, is structured differently than shown in FIG. 1.

The fabric 106 is representative of any communication interconnect that complies with any of various types of protocols utilized for communicating among the components of the processing system 100. The fabric 106 provides the data paths, switches, routers, and other logic that connect the CPU 102, parallel processor 104, second PP unit 134, memory 108, input/output (I/O) interface(s) 110, display controller 112, audio controller 114, power controller 116, and other devices to each other. The fabric 106 handles the request, response, and data traffic, as well as probe traffic to facilitate coherency. Interrupt request routing and configuration of access paths to the various components of the processing system 100 are also handled by the fabric 106. Additionally, the fabric 106 handles configuration requests, responses, and configuration data traffic. In at least some implementations, the fabric 106 is bus-based, including shared bus configurations, crossbar configurations, and hierarchical buses with bridges. In other implementations, the fabric 106 is packet-based and hierarchical with bridges, crossbar, point-to-point, or other interconnects. From the point of view of the fabric 106, the other components of processing system 100 are referred to as “clients”. The fabric 106 is configured to process requests generated by various clients and pass the requests on to other clients.

The memory 108 includes system memory or another storage component that is implemented using a non-transitory computer readable medium, such as dynamic random-access memory (DRAM), Static Random Access Memory (SRAM), NAND Flash memory, NOR (Not Or) flash memory, Ferroelectric Random Access Memory (FeRAM), or others. The I/O interface(s) 110 is/are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices are coupled to the I/O interface(s) 110. Such peripheral devices include, but are not limited to, displays, keyboards, mice, printers, scanners, joysticks or other types of game controllers, media recording devices, external storage devices, network interface cards, and so forth.

The audio controller 114 (also referred to as an “audio processing device”) generates audio signals that can be output by the audio controller 114 or another component of the processing system 100. The power controller 116, such as a system management unit (SMU) or another type of power controller, includes hardware and firmware for managing and accessing system configuration/status registers and memories, generating clock signals, controlling power rail voltages, and the like for the processing system 100. The power controller 116 also controls the power supplied to components and sub-components of the processing system 100, such as the cores of the CPU 102, parallel processor 104, the I/O interface 110, the display controller 112, the second PP unit 134, and the like.

The CPU 102, in at least some implementations, supports the execution of instructions for graphics and other types of workloads. For example, the CPU 102 executes instructions, such as program code 118, stored in the memory 108 and stores information in the memory 108, such as the results of the executed instructions. In another example, the CPU 102 prepares and distributes one or more operations to the parallel processor 104 (or other computing resources) and then retrieves the results of one or more operations from the parallel processor 104. The CPU 102 is also able to initiate graphics processing by issuing draw calls. In at least some implementations, the CPU 102 includes multiple processing elements (not shown in FIG. 1 in the interest of clarity) that execute instructions concurrently or in parallel. The processing elements are referred to as processor cores, compute units, or are described using other terms.

The parallel processor 104, in at least some implementations, is a processor such as a vector processor, a graphics processing unit (GPU), a general-purpose GPU (GPGPU), a non-scalar processor, a highly-parallel processor, an artificial intelligence (AI) inference engine, a machine learning (ML) engine, another multithreaded processing unit, a digital signal processor (DSP), a field programmable gate array (FPGA), an application specific integrated circuit (ASIC), or the like. The parallel processor 104, in at least some implementations, is constructed as a multi-chip module (e.g., a semiconductor die package) including two or more base integrated circuit (IC) dies communicably coupled together with bridge chip(s) or other coupling circuits or connectors such that a parallel processor is usable (e.g., addressable) like a single semiconductor integrated circuit. As used herein, the terms “die” and “chip” are interchangeably used. Those skilled in the art will recognize that a conventional (e.g., not multi-chip) semiconductor integrated circuit is manufactured as a wafer or as a die (e.g., single-chip IC) formed in a wafer and later separated from the wafer (e.g., when the wafer is diced); multiple ICs are often manufactured in a wafer simultaneously. The ICs and possibly discrete circuits and possibly other components (such as non-semiconductor packaging substrates including printed circuit boards, interposers, and possibly others) are assembled in a multi-die parallel processor.

In at least some implementations, the parallel processor 104 is an accelerated processor unit (APU) that combines, for example, a general-purpose CPU and a GPU such as an integrated GPU, or iGPU for brevity. In the illustrated embodiment, the iGPU is shown as the first PP unit 132. In these implementations, the APU accepts both compute commands and graphics rendering commands from the CPU 102 or another processor. The APU includes any cooperating collection of hardware, software, or a combination thereof that performs functions and computations associated with accelerating graphics processing tasks, data-parallel tasks, nested data-parallel tasks in an accelerated manner with respect to resources such as conventional CPUs, conventional GPUs, and combinations thereof. The APU and the CPU 102, in at least some implementations, are formed and combined on a single silicon die or package to provide a unified programming and execution environment. In other implementations, the APU and the CPU 102 are formed separately and mounted on the same or different substrates.

In some embodiments, the parallel processor 104 includes one or more processing elements, such as an array of compute units (not shown in FIG. 1 in the interest of clarity) that execute instructions concurrently or in parallel. Some implementations of the parallel processor 104 are used for general-purpose computing. The parallel processor 104 executes instructions stored in the memory 108 and stores information in the memory 108, such as the results of the executed instructions. For example, the memory 108 stores a copy 120 of instructions that represent a program code that is to be executed by the parallel processor 104.

The parallel processor 104, among other things, renders images and generates a stream of frames for presentation at one or more physical display devices 124 (one physical display device 124 illustrated for clarity), which may include, for example, a screen, a monitor, a television, etc. For example, the parallel processor 104 renders objects to produce values of pixels that are provided by the display controller 112 to the one or more physical displays 124, which use the pixel values to display an image that represents the rendered objects. In implementations where multiple physical displays 124 are coupled to the processing system 100, the parallel processor 104 generates the same image(s) to be presented on each physical display 124 or generates a different image(s) to be presented on two or more of the physical displays 124.

The display controller 112 reads out the pixel values in the frames from an output buffer/memory and uses the values to generate one or more signals for displaying an image on (or presenting an image to) the physical display 124. The display controller 112 provides the video signal representing the frames via a physical interface, such as a high-definition multimedia interface (HDMI) or DisplayPort interface, coupled to the physical displays 124. The display controller 112 includes one or more timing references 126 that generate control signals, synchronization signals, clock signals (independently or in conjunction with other circuitry or devices), a combination thereof, or the like that are required for interfacing to the physical display 124. In at least some implementations, the one or more timing references 126 are synchronized to, for example, a parallel processor timing reference (not shown for clarity purposes) during normal operation. Some implementations of the timing reference 126 are implemented in a timing controller (TCON) chip 128, e.g., as an ASIC or other circuit, which also performs timing and synchronization operations for the physical display 124. Although the display controller 112 is illustrated in FIG. 1 as being separate from other components of the processing system 100, the display controller 112, in other examples, is part of another component(s), such as the parallel processor 104, the I/O interface 110, or the like. For example, in some embodiments, the processing system 100 uses the first PP unit 132 (e.g., the iGPU) for display and the second PP unit 134 (e.g., the dGPU) for rendering, and thus the display controller 112 is connected to (e.g., via the data fabric 106) the parallel processor 104 with the first PP unit 132.

The processing system 100, in at least some implementations, includes one or more virtualization environments 140. The virtualization environment employs a first PP virtualized driver 142 to interface with the first PP unit 132 and a second PP native driver 144 to interface with the second PP unit 134 and to enable the second PP unit 134 to pass through into a virtual machine (not shown in FIG. 1) executing in the virtualization environment 140. The first PP unit 132 (also referred to as a “first PP circuit 132”) renders data for multiple virtual machines of the virtualization environment 140. The first PP unit 132, in at least some embodiments, is implemented using one or more of hardware components, circuitry, firmware or a firmware-controlled microcontroller, or a combination thereof. In at least some implementations, the first PP unit 132 is an integrated GPU (iGPU) of the parallel processor 104. That is, the iGPU is a hardware component for performing computations and tasks for workloads related to graphics processing (and other types of parallel processing tasks such as those associated with machine learning or the like) and is integrated on the parallel processor 104 along with other hardware components such as a CPU or the like. In the illustrated embodiment, the first PP unit 132, or the iGPU, communicates with the first PP virtualized driver 142 in the virtualization environment 140 and is used by the one or more VMs executing within the virtualization environment 140 to execute graphics related workloads (e.g., display or rendering operations).

In the illustrated embodiment, the processing system 100 includes a second PP unit 134 (also referred to as a “second PP circuit 134”) that is separate from the parallel processor 104. The second PP unit 134 provides increased processing capabilities, such as additional graphics processing or rendering capabilities, relative to relying on the first PP unit 132 alone. In some implementations, the second PP unit 134 is a discrete GPU (dGPU) that is formed on a chip or substrate separate from the parallel processor 104 and includes one or more discrete processor cores (not shown for clarity) with a higher processing or rendering capacity than the processor cores of the first PP unit 132. In some embodiments, the second PP unit 134 is implemented using other types of circuitry such as coprocessors, digital signal processors, application-specific integrated circuits (ASICs), field programmable gate arrays (FPGAs), and the like. The second PP unit 134 also has an independently controlled power plane that allows the voltages and frequencies that are provided to the second PP unit 134 (or the discrete processor cores in the second PP unit 134) to be controlled independently from those associated with the parallel processor 104 or the first PP unit 132. In this manner, the second PP unit 134 can be turned on (or activated) and turned off (or deactivated) independent from the parallel processor 104. In some embodiments, for heavier workloads requiring higher amounts of graphics processing, the parallel processor 104 or the CPU 102 generates a signal to turn on (or activate) the second PP unit 134 to provide additional graphics processing resources to accommodate the heavier workloads. Similarly, for lighter workloads that can be handled by the first PP unit 132, the parallel processor 104 or the CPU 102 generates a signal to turn off (or deactivate) the second PP unit 134 to conserve power. For example, in some embodiments, software executing at one of the components of the processing system 100 indicates the type of workload and issues an Advanced Configuration and Power Interface (ACPI) message to a basic input/basic output system (BIOS) interface in the processing system 100 to turn on (or turn off) the second PP unit 134. Thus, in some embodiments, the first PP unit 132 operates as the render engine (e.g., in lighter workload scenarios), and in other embodiments, the second PP unit 134 operates as the render engine (e.g., in heavier workload scenarios). In either case, the first PP unit 132 operates as the display engine. If the processing system 100 uses the first PP unit 132 (e.g., the iGPU) as both the render engine and the display engine, the processing system 100 powers the second PP unit 134 (e.g., the dGPU) off. If the processing system 100 uses the second PP unit 134 (e.g., the dGPU) as the render engine, the second PP unit 134 transfers the rendered graphics data in the virtualization environment 140 to the first PP virtualized driver 142 via the second PP native driver 144. The first PP virtualized driver 142 then passes the graphics data to the first PP unit 132 (e.g., the iGPU) operating as the display engine, which forwards the graphics data to the display controller 112.

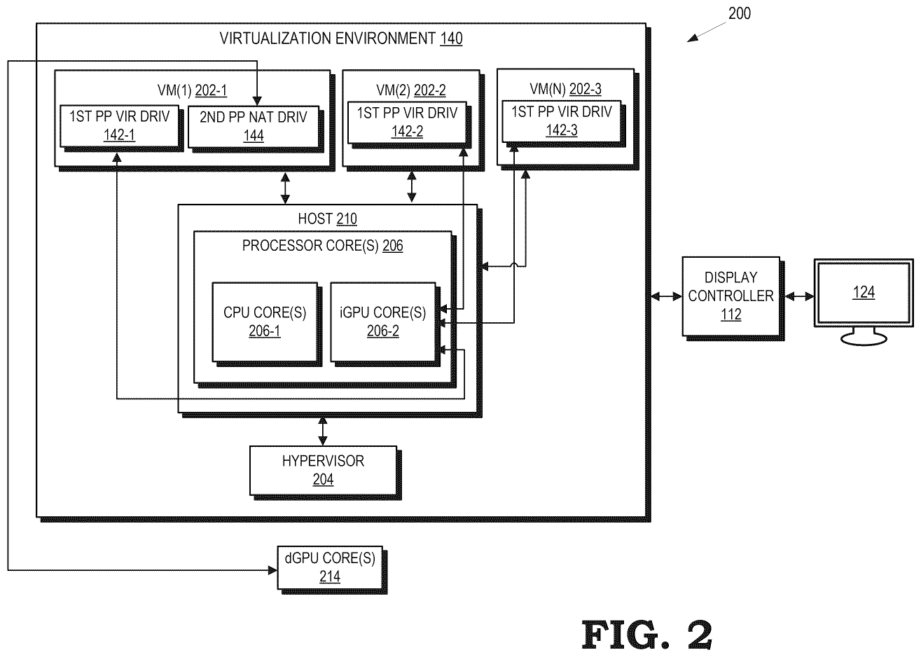

FIG. 2 shows an example of a processing system 200, such as one corresponding to the processing system 100 of FIG. 1, implementing a virtualization environment 140 that employs a VM hybrid graphics processing unit configuration in accordance with some embodiments. In this example, the virtualization environment 140 is instantiated with multiple virtual machines (VMs) 202 (illustrated as VM(1) 202-1 to VM(N) 202-3). The VMs 202, in at least some implementations, are configured in the system memory 108 of the processing system 100. Resources from physical devices, such as the iGPU core(s) 206-2 of the first PP unit 132 of the parallel processor 104 and the CPU core(s) 206-1 of the CPU 102 of the processing system 100 of FIG. 1, are shared with the VMs 202 via a host 210. The resources also may include, for example, a controller resource from display controller 112, a memory resource from memory 108 (not shown in FIG. 2 for clarity purposes), a network interface resource from a network interface controller, or the like. The VMs 202 use the resources for performing operations on various data (e.g., video data, image data, textual data, audio data, display data, peripheral device data, etc.). In at least some implementations, the processing system 200 includes a plurality of resources, which are allocated and shared amongst the VMs 202.

The processing system 200 also includes a hypervisor (HV) 204 (also known as a virtualization manager or a virtual machine manager) that manages instances of VMs 202 and a host 210. In some embodiments, the host 210 is a physical machine or virtualized software (e.g., an operating system) that provides resources (e.g., hardware devices) for the VMs to run on. The hypervisor 204 controls interactions between the VMs 202 and the various physical hardware devices, such as the CPU core(s) 206-1 and the iGPU core(s) 206-2. The hypervisor 204 includes software components for managing hardware resources and software components for virtualizing or emulating physical devices to provide virtual devices, such as virtual disks, virtual processors, virtual network interfaces, or a virtual parallel processor for each VM 202. In at least some implementations, each VM 202 is an abstraction of a physical computer system and may include an operating system (OS) and applications, which are referred to as the guest OS and guest applications, respectively, wherein the term “guest” indicates it is a software entity that resides within the VMs 202.

The VMs 202 generally are instanced, meaning that a separate instance is created for each of the VMs 202. It should be understood that the host 210 may support any number N of VMs. As illustrated, the hypervisor 204 provides N (in the illustrated embodiment, N=3) VMs 202, with each of the VMs 202 providing a virtual environment wherein guest system software resides and operates. The guest system software includes applications (not shown) and VM kernel mode drivers (KMDs) (not shown), typically under the control of a guest OS. The VM KMDs control the operation of hardware (e.g., CPU cores 206-1 or iGPU cores 206-2) by, for example, providing an API to software (e.g., applications) executing on the CPU 102 to access various functions of the hardware. In some implementations, the processing system 100 includes containers instead of, or in addition to, the VMs 202. In at least some of these implementations, the processing system 100 also comprises a container manager instead of, or in addition to, the hypervisor 204.

In at least some implementations, the host 210 manages or assists the hypervisor 204 to manage the overall virtualization environment 140. The host 210, in at least some implementations, runs a fully-featured operating system and directly interacts with the physical hardware of the processing system 200. In some embodiments, the host 210 manages the memory, processing resources, and direct access to Input/Output (I/O) devices of the processing system 200. For example, in the illustrated embodiment, the host 210 manages hardware resources such as the CPU cores 206-1 of a CPU (such as the CPU 102 of FIG. 1) and the iGPU cores 206-2 of an iGPU (such as the first PP unit 132 of FIG. 1).

In some embodiments, the host 210 controls the creation, execution, and termination of the guest VMs 202, effectively acting as the administrative authority in the virtualized environment 140 in addition with or in place of the hypervisor 204. The host 210 and/or the hypervisor 204, in at least some implementations, is also responsible for allocating hardware resources among the guest VMs 202 (e.g., VM(1) 202-1, VM(2) 202-2, and VM(N) 202-3), ensuring that each guest VM 202 has access to the necessary computing power, memory, and storage it requires to operate effectively. In at least some implementations, the host 210 and/or the hypervisor 204 also handles critical system-level functions, such as managing network configurations and storage operations. In some cases, other responsibilities of the host 210 and/or the hypervisor 204 include managing the device drivers needed for the physical hardware, which includes handling the complexities of network interfaces, storage controllers, and other essential hardware components.

A guest VM 202 is configured to operate within the confines of a controlled and isolated environment provided by the host 210 and/or the hypervisor 204. The guest VMs 202 allow for multiple isolated virtual environments to coexist on a single physical hardware platform. Unlike the host 210, which has direct access to the physical hardware such as the processor core(s) 206, a guest VM 202 operates in a more restricted environment. For example, in some cases, a guest VM 202 does not have direct access to the hardware resources. Instead, a guest VM 202 interacts with virtualized hardware resources that are allocated and managed by the host 210 or the hypervisor 204. For example, in the illustrated embodiment, each one of the VMs 202 include virtualized drivers to interact with the iGPU core(s) or the dGPU cores(s) 214 of the processing system 200. For example, the VM(1) 202-1 includes a first PP virtualized driver 142-1 to interact with the iGPU core(s) 206-2 and a second PP native driver 144 to interact with the dGPU core(s) 214. The VM(2) 202-2 includes a first virtualized PP driver 142-2 to interact with the iGPU core(s) 206-2, and the VM(N) 202-3 also includes a first virtualized PP driver 142-3 to interact with the iGPU core(s) 206-2. That is, each of the VMs 202 include respective first PP virtualized drivers 142 to interface with the iGPU core(s) 206-2. In addition, one VM is allocated a second PP native driver 144 (in this case, the VM(1) 202-1) for interfacing with the dGPU core(s) 214. This configuration ensures a clear separation and isolation of tasks and operations between different VMs 202, enhancing security and stability. Also, each guest VM 202 functions as an independent unit with its own operating system, applications, and virtualized hardware resources, such as CPU, a GPU, memory, and storage. These resources are assigned by the host 210 or the hypervisor 204, and the guest VMs 202 are typically unaware of the underlying physical resources or the presence of other VMs on the same host 210 (or processing system).

In the virtualized computing environment 140, each VM 202 is allocated a portion of hardware resources such as the CPU core(s) 206-1 and the iGPU core(s) 206-2. In at least some implementations, this allocation is managed through the use of the physical functions (PFs) and virtual functions (VFs). In at least some implementations, the iGPU cores 206-2 are virtualized using, for example, a GPU-Passthrough. Each VM 202 is allocated a VF, which acts as a virtual GPU. Within each VM 202, applications or processes that require graphics rendering use the allocated VF (virtual GPU). The VMs' 202 operating system and drivers interact with this VF as if it were a physical GPU, rendering images accordingly.

Each VM 202, in at least some implementations, is connected to one or more of the physical displays 124. In some cases, the GPU resource (e.g., one of the iGPU core(s) 206-2) allocates separate resources for each display, ensuring that they can operate independently and display different content. Once the images are rendered within each VM 202, the images are sent to the assigned physical displays 124. This transmission is a coordinated effort involving the processing system's 200 hardware capabilities and virtualization software, which ensures that each physical display 124 receives the correct image output from the respective VM 202.

Conventionally, VMs are limited to using the graphics resources of the iGPU, e.g., the iGPU core(s) 206-2. For example, for handling graphics processing workloads, conventional systems are limited to utilizing the iGPU cores 206-2 of the iGPU (e.g., the first PP unit 132 of FIG. 1), which may be insufficient for heavy graphics workload scenarios (e.g., such as a heavy graphics workload issued by a single VM 202 or a sum of workloads issued by multiple ones of the VMs 202). As such, in at least some implementations, the VM hybrid graphics processing unit configuration disclosed herein employs a set of dGPU core(s) 214 (e.g., from a second PP unit 134 of FIG. 1) to handle or assist in handling heavier graphics workloads for one VM 202 (e.g., the VM(1) 202-1 in the illustrated embodiment) of the multiple VMs 202. That is, in some embodiments, the processing system 200 is configured to utilize the dGPU core(s) 214 to execute a heavier workload for one of the VMs 202 when the iGPU cores 206-2 are not sufficient to execute the heavier workload. In some embodiments, the dGPU core(s) 214 are powered on to handle the heavier workload and are powered off when the virtualized iGPU cores 206-2 are sufficient to handle the workload. In one example, the heavier workload comes from one VM 202 (e.g., VM(1) 202-1) of the multiple VMs 202 and the dGPU core(s) 214 are activated and assigned to perform the workload for the VM(1) 202-1. In a second example, the heavier workload comes from multiple of the VMs 202 (e.g., VM(1) 202-1 to VM(N) 202-3), and the dGPU core(s) 214 are activated and assigned to perform the workload for one of the VMs 202 (e.g., the VM(1) 202-1), thus easing the workload for the iGPU core(s) 206-2 so that the iGPU core(s) 206-2 are allocated to perform the workloads of the VM(2) 202-2 and the VM(N) 202-3. In any case, the processing system employs a hybrid graphics processing unit configuration including the iGPU core(s) 206-2 of a first processing unit (e.g., the first PP unit 132 of FIG. 1) and the dGPU core(s) 214 of a second PP unit (e.g., the second PP unit 134 of FIG. 1) that are selectively turned on when needed or when selected by a user.

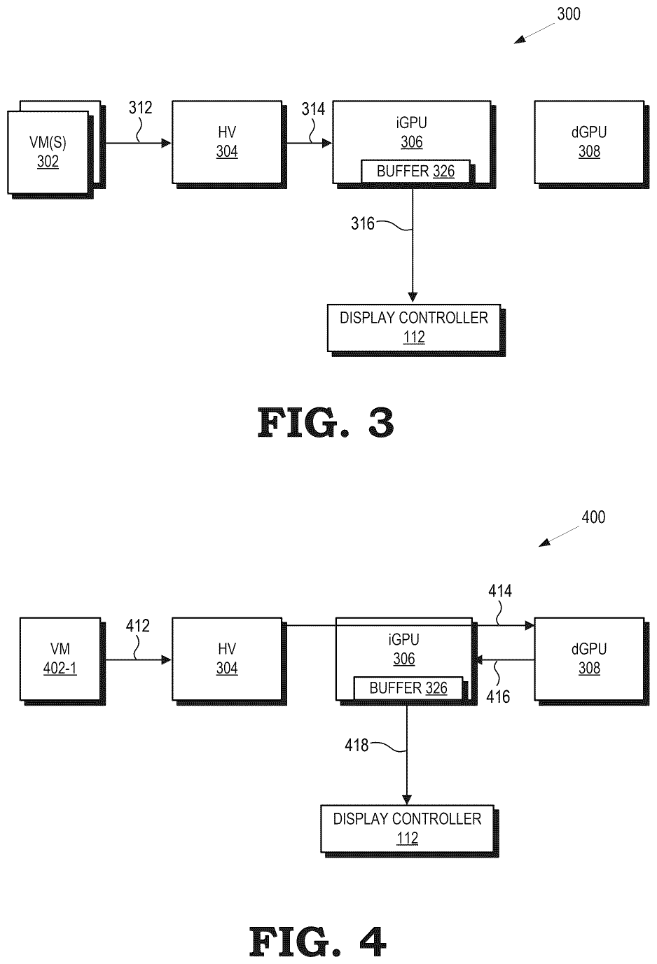

FIG. 3 shows an example diagram illustrating a first scenario 300 for a VM hybrid graphics processing unit configuration in a processing system (such as one of the processing system of FIG. 1 or 2) where the computational and/or bandwidth demands of the graphics workload from the VMs 302 are below a threshold. The VM hybrid graphics processing unit configuration includes VMs 302 (e.g., corresponding to VMs 202 of FIG. 2), a hypervisor (HV) 304 (e.g., corresponding to hypervisor 204 of FIG. 2), an iGPU 306 (e.g., corresponding to the first PP unit 132 of FIG. 1 or the iGPU cores 206-2 of FIG. 2), a dGPU 308 (e.g., corresponding to the second PP unit 134 of FIG. 1 or 2), and the display controller 112.

In the illustrated embodiment, the VMs 302 issue one or more requests 312 to execute a graphics workload utilizing the graphics resources of the virtualized iGPU 306 (or the iGPU cores 206-2 falling within the virtualization environment 140 of FIG. 2). Based on the graphics workload in the one or more requests 312 falling under a threshold (i.e., based on the computational demands of the operations in the one or more requests 312 falling below the threshold), the hypervisor 304 directs 314 the request to the iGPU 306 which performs the rendering operations associated with the graphics workload. That is, since the iGPU 306 has the computational resources to handle the computational and/or bandwidth demands associated with executing the graphics workload of the one or more requests 312, the graphics workloads are directed to the iGPU 306 for execution. After rendering, the iGPU 306 provides, at arrow 316, the rendered data (e.g., stored at buffer 326) to the display controller 112. In the illustrated embodiment, since the computational demands of the rendering operations associated with the graphics workload falls under the threshold and thus can be performed by the iGPU 306, the dGPU 308 is powered down, thereby conserving power.

FIG. 4 shows an example diagram illustrating a second scenario 400 for the VM hybrid graphics processing unit configuration shown in FIG. 3 where the computational and/or bandwidth demands of the graphics workload from the VMs 302 is above a threshold. The VM hybrid graphics processing unit configuration illustrating the second scenario shown in FIG. 4 includes one VM 402-1 of the plurality of VMs 302 shown in FIG. 3 (e.g., corresponding to one of the VMs 202 of FIG. 2), the hypervisor (HV) 304 (e.g., corresponding to hypervisor 204 of FIG. 2), the iGPU 306 (e.g., corresponding to the first PP unit 132 of FIG. 1 or the iGPU cores 206-2 of FIG. 2), the dGPU 308 (e.g., corresponding to the second PP unit 134 of FIG. 1 or 2), and the display controller 112.

In the illustrated embodiment, the plurality of VMs (e.g., the VMs 302 of FIG. 3) including the one VM 402-1 issue one or more requests to execute a graphics workload utilizing the graphics resources of the virtualized iGPU 306 (or the iGPU cores 206-2 falling within the virtualization environment 140 of FIG. 2). However, in this scenario, the computational and/or bandwidth demands of the graphics workload in the request 412 meets or exceeds the threshold, thereby indicating that the resources (e.g., the iGPU cores 206-2 of FIG. 2) of the iGPU 306 may not be able to handle the graphics workload in a timely or efficient manner. That is, the operations for at least the one VM 402-1 of the plurality of VMs (such as the VMs 302 shown in FIG. 3) place computational demands that exceed the threshold. Thus, the processor (e.g., the parallel processor 104 or the processor of FIG. 1) powers on the dGPU 308, and the hypervisor 304 passes the request 414 through the iGPU 306 to the dGPU 308. The dGPU 308 performs the rendering operations associated with the graphics workload. After rendering, the dGPU 308 passes 416 the data back to the iGPU 306, which stored the rendered data received from the dGPU 308 at the buffer 326, and then transmitting 418 the rendered data to the display controller 112. In this manner, the dGPU 308 is powered on to handle heaver graphics workloads that exceed the capacity of the iGPU 306, thereby extending the graphics processing capabilities of the VM 402-1 and improving performance.

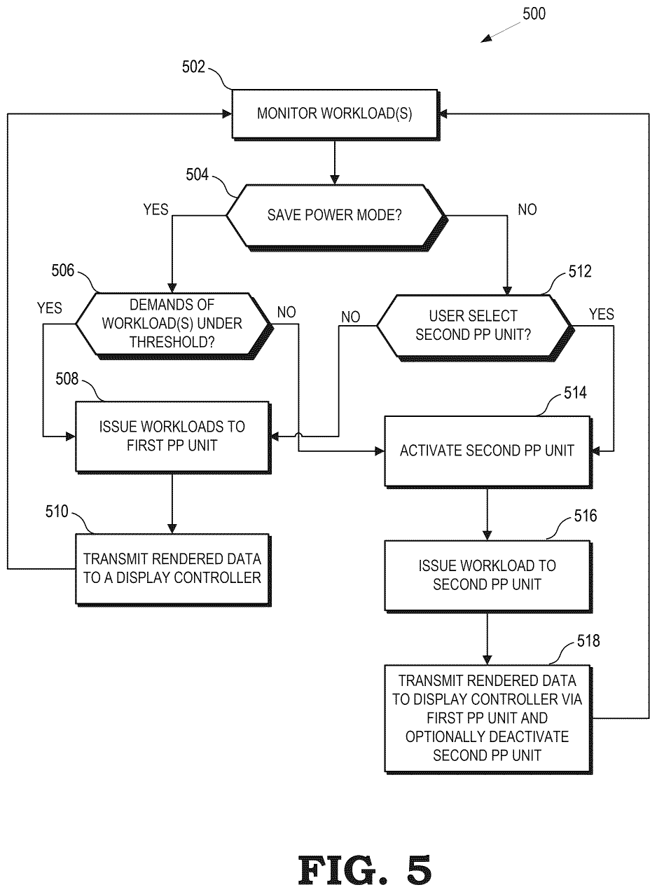

FIG. 5 shows an example of a flow diagram 500 illustrating a method for a processing system (such as the processing systems shown in FIGS. 1-4) to employ a VM hybrid graphics processing unit system in accordance with some embodiments.

At block 502, a processor (such as the CPU 102 of FIG. 1 or the parallel processor 104 of FIG. 1 or 2) monitors the workloads issued by one or more VMS operating within a virtualization environment (such as the VMs 202 operating within the virtualization environment 140 of FIG. 2). For example, in some embodiments, the workloads are associated with a graphics workload issued by one or more application executing on one of the VMs. At block 504, the processor determines whether the processing system is in save power mode. For example, the processing system is in save power mode if the second PP unit is turned off. If the processor is in save power mode (YES at block 504), the processor compares the computational and/or bandwidth demands of the workloads to a threshold at block 506. If the demands of the workloads are under the threshold (YES at block 506), the processor proceeds at block 508 to issue the workloads to a first parallel processing (PP) unit (such as the first PP unit 132 of FIG. 1, the iGPU core(s) 206-2 of FIG. 2, or the iGPU 306 of FIG. 3). At block 510, the first PP unit executes operations associated with the workload to render data and transmits the rendered data to a display controller (such as shown in the first scenario depicted in FIG. 3) for displaying images. Referring back to block 506, if the demands of the workloads meet or exceed the threshold (NO at block 506), the processor proceeds at block 514 to activate (or power on) a second PP unit (such as the second PP unit 134 of FIG. 1 or 2 or the dGPU of FIG. 3 or 4). At block 516, the processor issues the workload to the second PP unit. In some cases, this includes issuing the workload to pass through to the second PP unit (e.g., the dGPU) as shown in the scenario depicted in FIG. 4. At block 518, the second PP unit executes operations associated with the workload to render data and transmits the rendered data to the first PP unit (e.g., the iGPU), and then the first PP unit forwards the rendered data for display to the display controller. For example, in some embodiments (and as shown in FIG. 4), this includes the second PP unit (or the dGPU) transmitting the data to the first PP unit (or the iGPU), which then forwards the rendered data to the display controller. In some cases, block 518 also optionally includes powering down the second PP unit after the rendering is complete, thereby conserving power. Referring back to block 504, if the processing system is not in save power mode (NO at block 504), the processor determines whether the user has selected the second PP unit at block 512. If the user has not selected the second PP unit (NO at block 512), the processor proceeds to blocks 508-510. If the user has selected the second PP unit (YES at block 512), the processor proceeds to blocks 514-518.

In some embodiments, the VM hybrid graphics processing unit configuration techniques of FIGS. 1-5 are implemented in an automotive system. For example, the content that is rendered by any one of the first PP unit (e.g., the iGPU) and the second PP unit (e.g., the dGPU) is displayed at one or more display screens (e.g., a dashboard display, a central console display, or the like) of an automobile.

In some embodiments, the apparatus and techniques described above are implemented in a system including one or more integrated circuit (IC) devices (also referred to as integrated circuit packages or microchips), such as the parallel processor (including the first PP unit) or the second PP unit described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A system comprising:
a first parallel processing unit shared among a plurality of virtual machines (VMs), the first parallel processing unit to execute operations for the plurality of VMs based on computational demands of the operations falling below a threshold; and
a second parallel processing unit to execute operations for one VM of the plurality of VMs based on the operations for at least one VM of the plurality of
VMs placing computational demands that exceed the threshold.

2. The system of claim 1, further comprising:
a processor to cause the second parallel processing unit to power on responsive to the operations for the at least one VM placing computational demands that exceed the threshold.

3. The system of claim 2, wherein the second parallel processing unit transfers data from executing the operations for the at least one VM to the first parallel processing unit.

4. The system of claim 3, wherein the first parallel processing unit provides the data to a display controller of the system.

5. The system of claim 4, wherein the display controller controls one or more displays of the system responsive to the data received from the first parallel processing unit.

6. The system of claim 2, wherein the processor allocates the second parallel processing unit to one VM of the plurality of VMs.

7. The system of claim 6, wherein the second parallel processing unit allocated to the one VM is not shared with other VMs of the plurality of VMs while the second parallel processing unit is allocated to the one VM.

8. The system of claim 2, wherein the processor causes the second parallel processing unit to power down responsive to the operations of the plurality of VMs placing computational demands that are under the threshold.

9. The system of claim 1, wherein the first parallel processing unit is an integrated graphics processing unit (iGPU) on a parallel processor.

10. The system of claim 9, wherein the second parallel processing unit is a discrete graphics processing unit (dGPU) separate from the parallel processor.

11. A processor to:
execute a plurality of virtual machines (VMs);
allocate operations of the plurality of VMs to a first parallel processing unit responsive to the operations of the plurality of VMs placing computational demands that are below a threshold; and
in response to operations of at least one VM of the plurality of VMs placing computational demands that meet or exceed the threshold, allocate the operations of one VM of the plurality of VMs to a second parallel processing unit for execution.

12. The processor of claim 11, wherein the processor is further configured to receive a data resulting from executing the operations for the one VM from the second parallel processing unit.

13. The processor of claim 12, wherein the processor is further configured to provide the data to the first parallel processing unit for displaying images at one or more displays coupled to the processor.

14. The processor of claim 11, wherein the second parallel processing unit allocated to the one VM is not shared with other VMs of the plurality of VMS while the second parallel processing unit is allocated to the one VM.

15. The processor of claim 11, wherein the processor is further configured to cause the second parallel processing unit to power on prior to allocating the operations of the one VM to the second parallel processing circuit.

16. The processor of claim 15, wherein the processor is further configured to cause the second parallel processing unit to power down responsive to the operations of the plurality of VMs placing computational demands that are under the threshold.

17. The processor of claim 11, wherein the first parallel processing unit is an integrated graphics processing unit (iGPU) on a parallel processor, and wherein the second parallel processing unit is a discrete graphics processing unit (dGPU) separate from the parallel processor.

18. A method comprising:
executing a plurality of virtual machines (VMs);
allocating, by a processor, a first parallel processing unit to at least one VM of the plurality of VMs responsive to operations of the at least one VM placing computational demands that are up to a threshold; and
allocating, by the processor, a second parallel processing unit to one VM of the plurality of VMs responsive to the operations of the plurality of VMs placing computational demands that exceed the threshold.

19. The method of claim 18, further comprising:
powering on the second parallel processing unit responsive to the operations of the plurality of VMs placing computational demands that meet or exceed the threshold.

20. The method of claim 19, further comprising:
powering down the second parallel processing unit responsive to the operations of the plurality of VMs placing computational demands that are under the threshold.
